(19) United States
(12) Patent Application Publication
(10) Pub. No.: US 2020/0138069 A1
(43) Pub. Date: May 7, 2020

(54) Coated Snacks

(71) Applicant: Kraft Foods Group Brands LLC, Chicago, IL (US)

(72) Inventors: Hayley L. Theodorakakos, Washington, DC (US); Nathaniel R. Morrison, Chicago, IL (US); Daniel L. Bloomfield, Buffalo, IL (US); Ammar N. Chinwalla, Northbrook, IL (US)

(21) Appl. No.: 16/671,798

(22) Filed: Nov. 1, 2019

Related U.S. Application Data
(60) Provisional application No. 62/754,357, filed on Nov. 1, 2018.

(51) Int. Cl. A23L 25/00; C08L 3/02

(52) U.S. Cl. CPC A23L 25/25; A23V 2002/00; C08L 3/02

(57) ABSTRACT

Coated seed products with a roasted flavor and a crunchy, crispy starch coating are provided. In another aspect, the coated seed products are provided without a high level of saturated fat.

### CROSS-REFERENCE TO RELATED APPLICATION

This application claims the benefit of U.S. Provisional Application No. 62/754,357, filed Nov. 1, 2018, which is incorporated herein by reference in its entirety.

### FIELD

This application relates generally to coated snack foods, and more particularly to a crunchy, starch-based coating for seeds and the like.

### BACKGROUND

Edible seeds include a wide variety of nuts, kernels, legumes, beans, and the like. Examples include peanuts, almonds, pistachios, cashews, hazelnuts, filberts, macadamia nuts, Brazil nuts, pine nuts, pecans, walnuts, pine nuts, sunflower seeds, pumpkin seeds, cocoa seeds, grains, coffee beans, and the like. Edible seeds are often combined with other ingredients by snack food manufacturers, confectioners, ice cream manufacturers, cereal manufacturers, bakers, chefs, and cooks. Seeds can be a source of dietary protein and fiber. Seeds such as nuts that are packaged for consumers often have been removed from a shell, and in some cases, have had a seed coat removed. Roasting processes may use forced air ovens, oil fryers, or other heating methods to develop a roasted nut flavor and crunchy texture.

As described in U.S. Pat. No. 8,771,769, flavors may be infused into seeds. Additionally, or as an alternative, coatings may be provided. Some coated nut products may have issues including: 1) coatings that are perceived as soggy, burned, or oily; 2) a green or raw taste; 3) an unattractive appearance; 4) high saturated oil content; and/or 5) an unacceptably high percentage of nuts that are split or “married,” i.e., joined to other nuts. The rate at which nuts are joined or married during a coating process can be dependent on the coating composition. In some coating processes, the desirable characteristics of a coating that enable it to adhere to an underlying seed or other substrate may also lead to undesirably high rates of joinder, leading to a product in which high numbers of clumps of two or more coated seeds may be present.

In currently available snack foods, raw nuts may be coated prior to cooking. The coated, raw nuts may need to be baked, roasted or fried for a significant time to ensure that the nut is cooked. However, providing adequate heat transfer to the nut may result in the coating being overcooked or burned. In contrast, if the heat transfer to the coated, raw nut is for an insufficient time, the nut may retain a green (i.e., raw, not roasted) taste.

Cooking after coating also poses potential problems with the texture of the coating. As water is released when a coated, raw nut is cooked, water can escape through or become trapped in the coating, which may result in a coating that is soggy, sticky, or has other undesirable organoleptic properties. Starch-based coatings may retain water and may result in a cooked dough coating that does not have the crispness or crunchiness desired. If the coated, raw nut is fried, the coating may be crunchy but also may trap some oil which may result in an oily mouthfeel when the coated nut is consumed. Further, frying the coated, raw nut may increase the amount of saturated fat in the product, which can be undesirable.

When a peanut is cooked, release of water can cause fissures or splits in the nuts. In producing a coated peanut product, coating of raw peanuts prior to cooking may be advantageous to produce an even coating, because raw peanuts may have less splits and fissures than cooked nuts. If the cooking is completed prior to coating, the coating may clump in fissures to provide an uneven coating.

There is a need for a coated seed product with a roasted flavor and a crunchy, crispy starch coating without a high level of saturated fat.

### BRIEF DESCRIPTION OF DRAWINGS

FIG. 1 is a front elevation view of a coated snack food.

FIG. 2 is a perspective view of the coated snack food in FIG. 1, with the coating partially removed.

FIG. 3 is a front elevation view of three coated snack foods of the same variety.

FIG. 4 is a perspective view of the coated snack foods in FIG. 3, with coatings partially removed.

FIG. 5 is a flow chart of an example of a process to produce the coated snack food of FIG. 1.

FIG. 6 is a graph from texture analysis conducted on coated seeds in Experiment 1 Replicate 2.

FIG. 7 is a graph from texture analysis conducted on coated seeds in Experiment 2 Replicate 1.

FIG. 8 is a graph from texture analysis conducted on coated seeds in Experiment 2 Replicate 4.

FIG. 9 is a graph from texture analysis conducted on coated seeds in Experiment 3 Replicate 3.

FIG. 10 is a graph from texture analysis conducted on coated seeds in Experiment 3 Replicate 10.

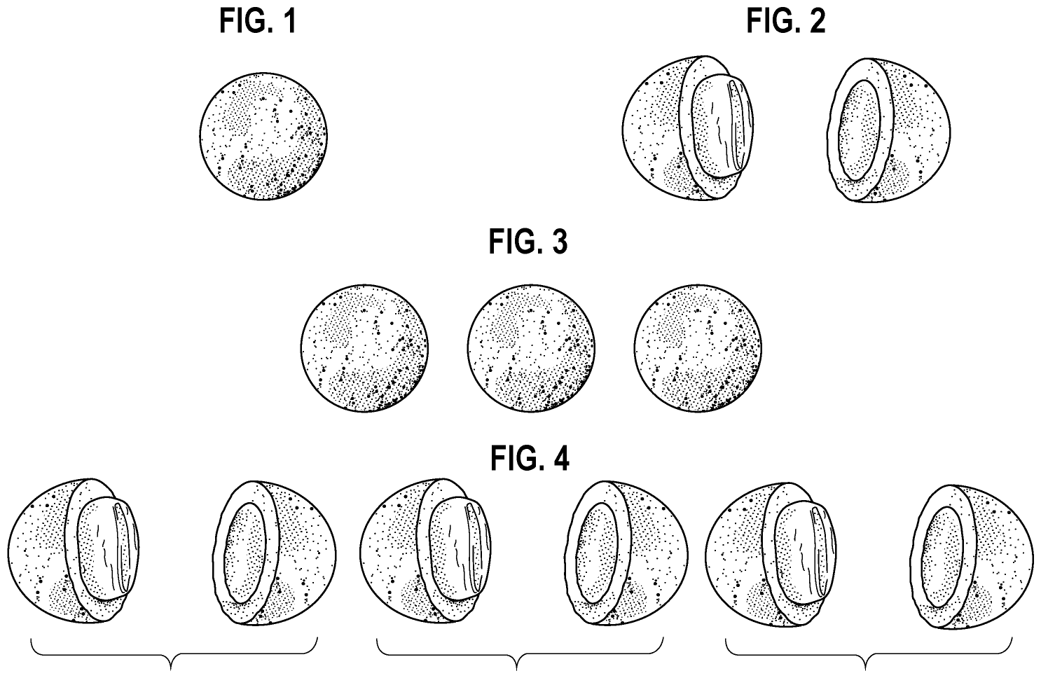

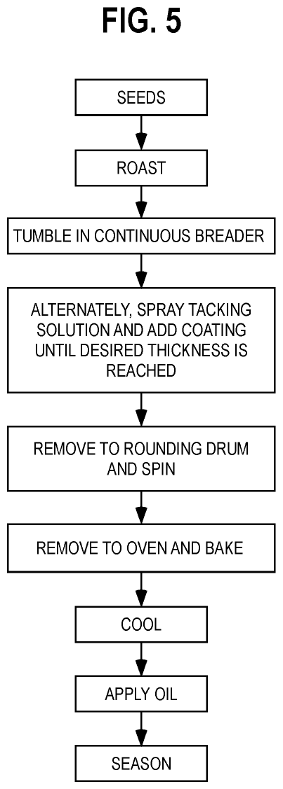

### DETAILED DESCRIPTION

Described herein is a coated seed product with a roasted flavor and a crunchy, crispy starch coating without an unacceptably high level of saturated fat. In some embodiments, seeds are coated with a starch-based, seasoned, edible coating. Seasonings may include, for example, all spice, anise, annatto, basil, bay, black pepper, decolorized black pepper, capsicum, cardamom, carrot, celery, French celery, sweet celery, chipotle, chive, cilantro, cinnamon, clove, coriander, cumin, dill, fennel, fenugreek, French onion, fried garlic, fried onion, fried shallot, garlic, ginger, green ginger, green onion, horseradish, jalapeno, kaffir lime, leek, lemongrass, mace, marjoram, mustard, nutmeg, onion, paprika, rosemary, sage, shallot, tarragon, thyme, turmeric, white pepper, and mixtures thereof. Seasonings may also include regional spice blends and extracts, such as barbeque, Cajun, cheddar sour cream, chili spice blends, Chinese 5-spice, curry blends, fajita, frankfurter, fried chicken, lemon pepper, nacho cheese seasoning, pepperoni, pizza, rendang, salsa, sour cream and onion, taco, tom yam, wasabi, Worcestershire, and mixtures thereof. In some embodiments, the starch-based edible coating may not be seasoned.

In some embodiments, the seeds are 41% to 51% total weight of the coated seed product, 43% to 49%, or about 46%. Seeds suitable for coating may include, for example, a wide variety of nuts, kernels, legumes, beans, and the like. Examples include almonds, pistachios, cashews, hazelnuts, filberts, macadamia nuts, Brazil nuts, pine nuts, pecans, walnuts, pine nuts, sunflower seeds, pumpkin seeds, cocoa seeds, grains, coffee beans, chia seeds, flaxseeds, sesame seeds, hemp seeds, and the like. In some embodiments, the seed may be a peanut and may include varieties, such as Runners, Virginia, Spanish and Valencia, and sizes, such as Jumbo, Medium, Fancy, Extra Extra Large, Extra Large, #1, and #2. In one embodiment, the seeds are Medium Runners. In another embodiment, the seeds are Jumbo Runners. The seeds may be infused with one or more of the seasonings listed above.

The seeds may be enveloped in an edible coating then cooked. In some embodiments, the edible coating includes potato starch, rice flour, tapioca flour, sugar, corn starch, and sea salt. In some embodiments, the potato starch may be in an amount of 13% to 23% total weight of the coated seed, 16% to 20%, or about 18%. In some embodiments, the rice flour may be in an amount of 11% to 21% total weight of the coated seed, 14% to 18%, or about 16%. In some embodiments, the tapioca flour may be in an amount of 1% to 9% total weight of the coated seed, 3% to 7%, or about 5%. In some embodiments, the sugar may be in an amount of 6% to 16% total weight of the coated seed, 9% to 13%, or about 11%. In some embodiments, the corn starch may be in an amount of 0.5% to 7% total weight of the coated seed, 2.5% to 5%, or about 3%. In some embodiments, the sea salt may be in an amount of 0.25% to 5% total weight of the coated seed, 0.5% to 3%, or about 1%.

One of the challenges of producing a seed with an edible coating is that the coating may remain soggy or oily after the seed is cooked. The coated seed may be cooked by blanching, steaming, frying, roasting, boiling, grilling, poaching, or microwaving or any other method. In some embodiments, the coated seed is baked. The baking may prevent the cooked, coated seed from appearing or tasting soggy or oily in that baking allows the flour and the starch to expand and the coated seed to be cooked without the coated seed soaking up moisture or oil. In some embodiments, the edible coating will release moisture when baked and will allow the coating to expand to create evenly-coated, properly-shaped seeds. In some embodiments, the moisture content of the coated, cooked seed is less than 2% total weight.

In some embodiments, the seed is lightly oil-fried or oil-roasted prior to coating so that the seed may have a roasted flavor. Otherwise, the seed may have a green or raw taste, which may occur when the coated seed is baked for a short time or at a low temperature without being roasted in advance. The smaller amount of heat transfer may help ensure that the coating does not burn but may not allow the seed to cook completely and thus may leave the seed with a green or raw taste. In other embodiments, the seeds may be blanched, steamed, baked, roasted, boiled, grilled, poached, microwaved or heated with another process prior to coating.

Another challenge encountered cooking coated seeds is avoiding high saturated oil content. To obtain a crispy coating, some seeds are fried after they are coated. However, in some embodiments described herein, the seed is cooked prior to coating, so less moisture is present in the seed, and the seed is baked after coating. Less water is available to escape or evaporate from a cooked seed during baking, so the coating is less likely to become soggy as it is baked. Further, baking avoids the absorption of oil associated with frying. Baking a pre-cooked coated seed may thus result in a cooked, coated nut that is crispy and crunchy but still has a fairly low saturated oil content. In some embodiments, the weight percent of total fat in the cooked, coated seed does not exceed about 25% of the total weight. In some embodiments, the saturated fat does not exceed about 4% of the total weight of the cooked, coated seed.

Another challenge is that the appearance of coated seeds can be unattractive. For example, it may be generally desirable that a coated peanut kernel have a generally ellipsoidal or rounded shape similar to that of a typical uncoated, shelled peanut kernel. However, during a typical coating process, a significant percentage of kernels may break into smaller portions rather than remaining intact. Another issue is that a significant percentage of kernels may stick together with one or more other kernels, creating “married” coated kernels. Still another issue is that a coating may be applied unevenly and inconsistently, resulting in bare spots where no coating is applied, or unacceptable variations in coating thickness. These issues may be addressed by a combination of coating composition and process parameters.

Exemplary embodiments of a process for making a coated seed product are described below. In these embodiments, the seed may be lightly oil-fried or otherwise partially cooked prior to coating. The partially cooked seed may then be transferred to a continuous breader, where multiple thin layers of coating are applied, one at a time, over the seed. The coating may be added by alternately applying a tacking solution and dry powder coating until the desired total thickness of coating is reached. The density of the seed with the wet coating may be between approximately 0.67 g/mL and approximately 0.70 g/mL.

In some embodiments, the tacking solution may comprise water, sugar, and at least one starch. In some embodiments, the amount of water in the tacking solution may be between 40 wt % and 50 wt %, between 43 wt % and 47 wt %, or about 44.4 wt % of the tacking solution. In some embodiments, the amount of sugar in the tacking solution may be between 40 wt % and 50 wt %, between 43 wt % and 47 wt %, or about 44.4 wt % of the tacking solution. In some embodiments, the amount of the least one starch in the tacking solution may be less than 20%, less than between 10 wt % and 15 wt %, or about 11.1 wt % of the tacking solution.

In some embodiments, the at least one starch may be, for example, potato starch, modified potato starch, tapioca starch modified tapioca starch. pea starch, modified pea starch, corn starch, modified corn starch, or combinations thereof.

The tacking solution may be applied in equal increments to the seed or may be applied in unequal increments. For example, about 10 wt %, about 15 wt %, about 20 wt %, about 25 wt %, or about 30 wt % of the overall tacking solution may be initially applied to the seed in the breader to help adhere the first layer of coating, then equal increments thereafter to help adhere additional layers of coating to a desired thickness. In some embodiments, the total number of increments of tacking solution added may be between 7 and 13, between 8 and 12, between 9 and 11 or about 10.

Once the coated seeds are removed from the continuous breader, they may be added to a rounding drum which allows the starch in the coating to fully hydrate and shape it. Any pieces or skins that have broken off the coated seeds may be reincorporated into the coatings of the coated seeds during spinning in the rounding drum. The wet, coated seeds may be baked in an oven to allow the edible coating to cook and expand. In some embodiments, the cooked, coated seeds may have edible coatings with thicknesses between 0.020 inches and 0.165 inches, between 0.070 and 0.115 inches, or about 0.1 inches. The maximum standard deviation of the coating on an individual cooked, coated seed may be about 0.015 inches. The density of the cooked, coated seeds may be between 0.35 g/mL and 0.43 g/mL.

The residence time in the oven may be, for example, between 8 and 14 minutes, between 10 and 14 minutes or about 13 minutes. The oven may be a modular rotary oven, an accelerated cooking oven, a convection oven, a steam oven, a combination oven, a conveyor oven, or a toaster oven.

After baking, the cooked, coated seeds may be allowed to cool prior to tumbling in an oil. Examples of oils that may be used include almond, canola, cherry pit, coconut, corn, linseed, grape seed, hemp, macadamia, mango butter, mustard, peanut, rapeseed, safflower, sesame, shea butter, and sunflower oils. Seasoning may then be applied to the oiled, cooked, coated seeds. The seasoning may be adhered by additional tacking solution. In a processes of producing some embodiments, the number of mis-formations, incompletely coated seeds, double coated seeds, broken seeds and marriages may be less than about 5%, less than about 4%, less than about 3%, less than about 2%, or less than about 1% of the total amount of cooked, coated seeds produced.

Crunchiness of the final coated snack may be quantified by analyses of the texture of the cooked, cooled, coated, seasoned seeds. For example, the texture of samples of coated, medium Runner peanuts created as disclosed herein was analyzed by a TAXT-2 instrument (Texture Technologies located in South Hamilton, Mass.) equipped with a TA-91M (Mini Kramer Cell 5 Blades) probe. A 50 kg load cell was used to test a sample amount of 2 coated seeds, the seeds having a total weight of 2.6-3.0 g. The TAXT-2 texture analyzer was set to a stroke speed of 5 mm/sec with an end condition of a 30-mm extension.

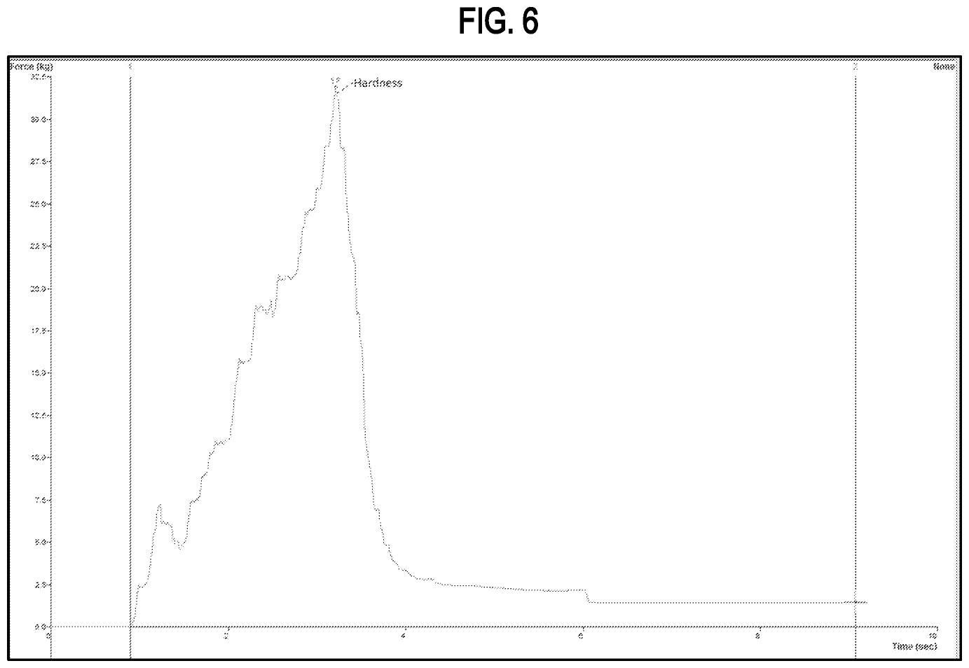

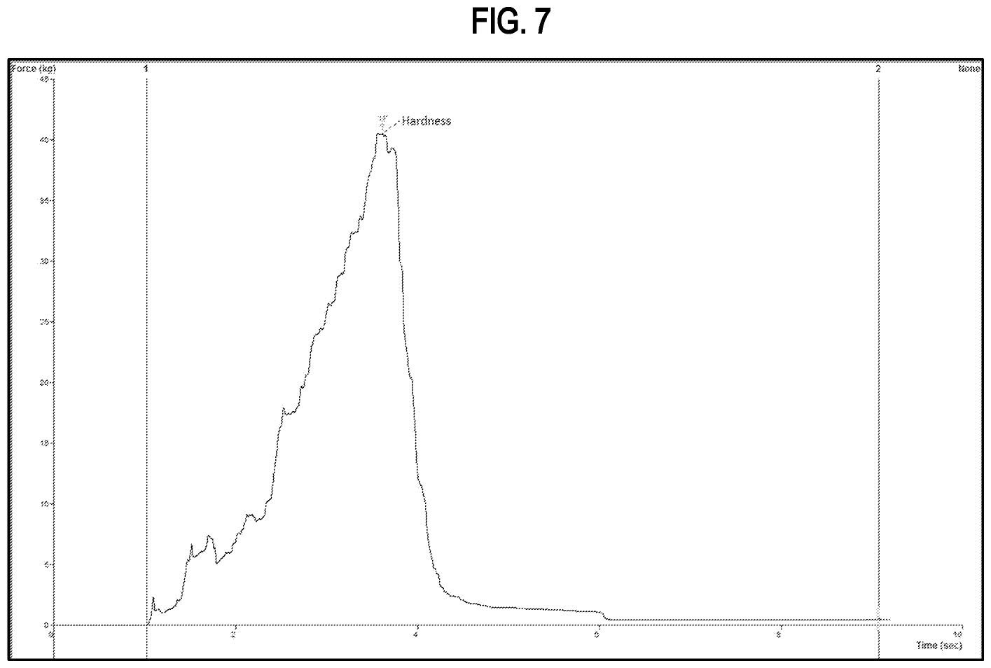

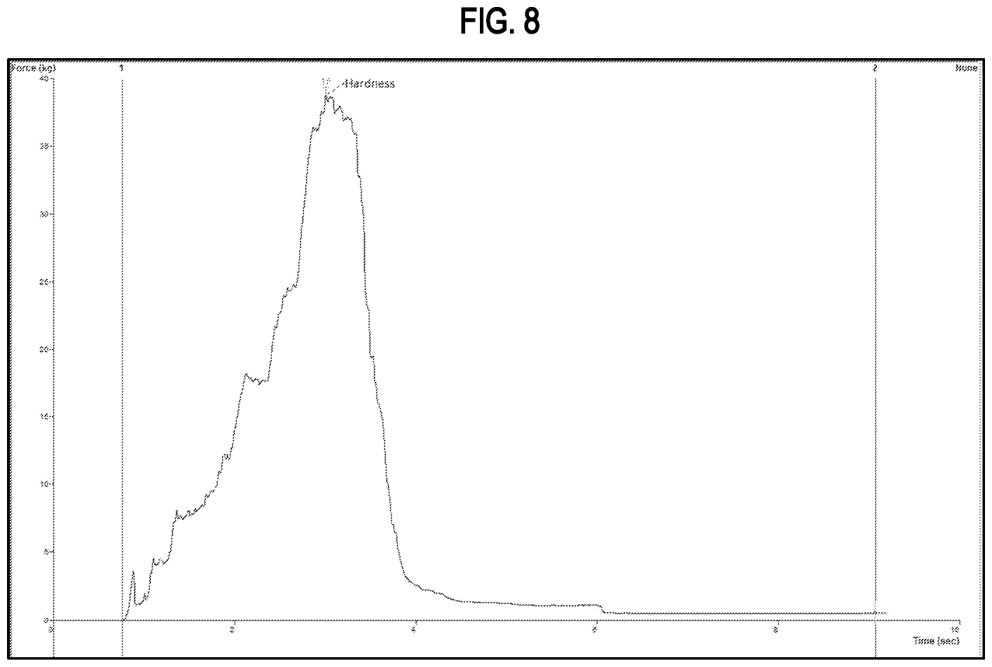

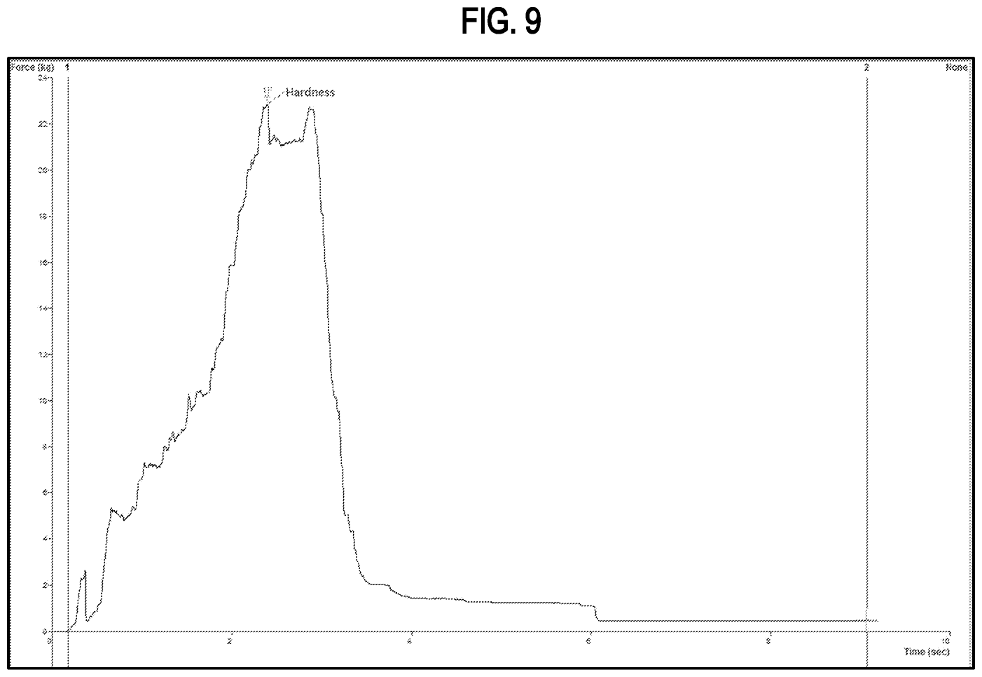

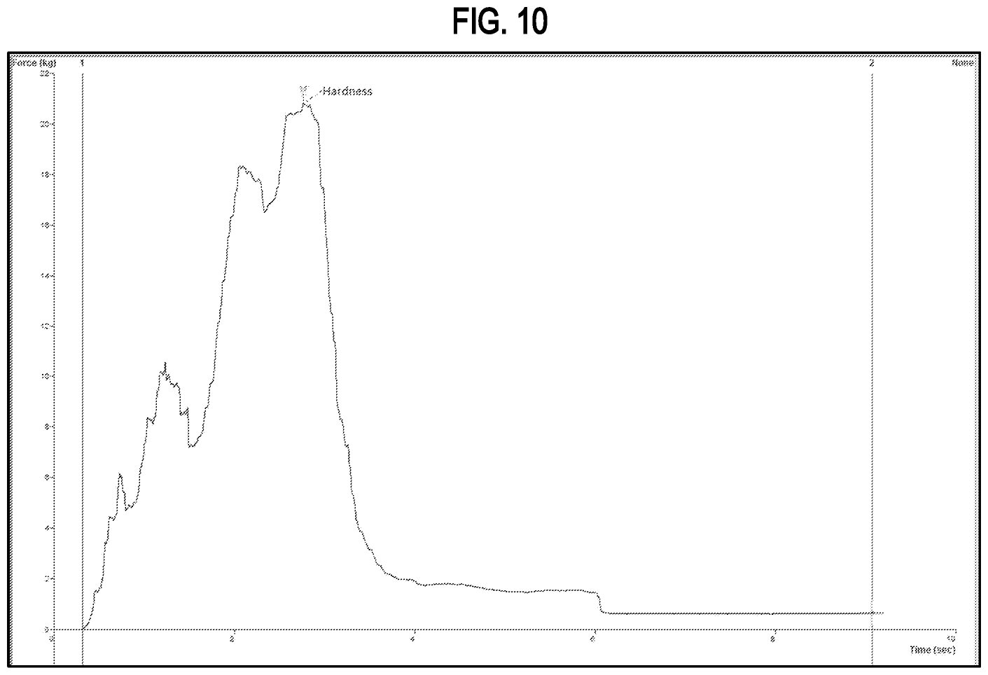

The TAXT-2 measures the amount of force and time needed to meet the end condition at the set stroke speed. During analysis, the force and time are recorded and a graph is generated to illustrate the results. The peak of the curve in the graph is indicative of the hardness of the sample and is believed to be approximately proportional to the peak force of a user's jaw needed to masticate the sample. The linear distance of the curve (as well as its peaks and valleys) is indicative of crispiness and crunchiness of a sample. FIGS. 6-10 are examples of graphs generated when the TAXT-2 analyzed the texture of the samples described below.

Three samples were tested. Testing for each sample was replicated 10 times. The data for the replications of three samples are shown below in Table 1. Experiment 1 included coated peanuts produced according the process and composition disclosed herein. Experiments 2 and 3 included coated peanuts produced with process and composition deviations, such as different ingredient ratios from the compositions disclosed herein and different amounts of time in the rounding drum to create a thinner or thicker coating on the peanuts, which resulted in coatings with undesirable hardness.

In some embodiments analyzed with the above-noted parameters, the hardness measured may be between 26 kg and 35 kg, between 28 kg and 33 kg, or about 31 kg. In some embodiments analyzed with the above-noted parameters, the linear distance of the stroke may be between 74 kg*s and 90 kg*s, between 78 kg*s and 86 kg*s, or about 82 kg*s.

TABLE 1

| | Experiment 1 | | Experiment 2 | | Experiment 3 | |
|---|---|---|---|---|---|---|
| | Hardness | Linear | Hardness | Linear | Hardness | Linear |
| Sample | (kg) | Distance | (kg) | Distance | (kg) | Distance |
| Replicate 1 | 25.12 | 73.19 | 40.57 | 103.98 | 26.90 | 71.32 |
| Replicate 2 | 31.49 | 84.12 | 33.36 | 90.62 | 28.30 | 74.65 |
| Replicate 3 | 23.96 | 67.64 | 39.92 | 94.71 | 22.87 | 70.07 |
| Replicate 4 | 34.32 | 91.44 | 38.84 | 104.54 | 26.99 | 80.44 |
| Replicate 5 | 34.08 | 92.13 | 25.99 | 77.99 | 27.81 | 75.38 |
| Replicate 6 | 24.37 | 79.52 | 35.06 | 93.54 | 24.63 | 73.73 |
| Replicate 7 | 33.67 | 85.70 | 35.16 | 95.64 | 26.32 | 73.90 |
| Replicate 8 | 37.23 | 88.10 | 38.89 | 98.70 | 34.84 | 87.66 |
| Replicate 9 | 33.68 | 89.15 | 25.36 | 79.74 | 27.96 | 76.23 |
| Replicate 10 | 28.75 | 74.29 | 28.68 | 103.84 | 20.84 | 66.49 |
| Average | 30.67 | 82.53 | 34.18 | 94.33 | 26.75 | 74.99 |

Each of the various features described above may be used in combination with any other compatible features described above, or with features not described herein. Various aspects of the products and processes described herein are further described in the following claims.

What is claimed is:

1. A coated snack food comprising:
41 wt % to 51 wt % seeds; and
49 wt % to 59 wt % edible coating, wherein the edible coating comprises:
13 wt % to 23 wt % potato starch;
12 wt % to 30 wt % flour;
6 wt % to 16 wt % sugar;
0.5 wt % to 7 wt % corn starch; and
0.25 wt % to 5 wt % sea salt.

2. The coated snack food of claim 1, wherein the edible coating further comprises rice flour and tapioca flour, and wherein the coating is crunchy.

3. The coated snack food of claim 2, wherein the edible coating further comprises 11 wt % to 21 wt % rice flour and 1 wt % to 9 wt % tapioca flour.

4. The coated snack food of claim 1, wherein a thickness of the edible coating is 0.020 in. to 0.165 in.

5. The coated snack food of claim 1, wherein the thickness of the edible coating on an individual piece has a maximum standard deviation of 0.015 inches throughout the edible coating.

6. The coated snack food of claim 1, further comprising a seasoned coating.

7. The coated snack food of claim 1, wherein a weight percent of total fat does not exceed about 25% of the total weight of the coated snack food.

8. The coated snack food of claim 1, wherein a weight percent of saturated fat does not exceed about 4% of a total weight of the coated snack food.

9. The coated snack food of claim 1, wherein the seeds are medium Runner peanuts.

10. A coated snack food prepared by a process comprising:
(a) providing seeds;
(b) roasting the seeds in oil;
(c) after roasting the seeds in oil, adding the seeds to a continuous breader having a rotating drum that provides limited tumbling of the seeds within the drum, with the rotation of the drum providing centrifugal force that limits tumbling of the seeds;
(d) spraying a tacking solution comprising water and sugar onto the seeds in the continuous breader to wet the seeds and to enable adhesion of dry powder thereto;
(e) thereafter adding a dry powder consisting essentially of the edible coating of claim 1 to provide a coating layer on the seeds;
(f) repeating steps (d) and (e) to provide additional coating layers until a desired total coating thickness is achieved;
(g) removing the wet, coated seeds from the continuous breader;
(h) spinning the seeds in a rounding drum to reincorporate any seed skin that pulled away from the seed in the continuous breader;
(i) baking the wet, coated seeds in an oven to make the coating crunchy while evaporating water therefrom so that the coating has hardness of at least 20 kg when analyzed for texture;
(j) cooling the cooked, coated seeds;
(k) applying oil to the cooked, coated seeds;
(l) tumbling the cooked, coated seeds; and
(m) applying seasoning to the cooked, coated seeds.

11. The coated snack food prepared by the process of claim 10, wherein a yield loss of coated, cooked seeds, due to misformation, splits, and marriages, is less than 1%.

12. The coated snack food prepared by the process of claim 10, wherein the coated seeds reside in the oven for less than about 10 minutes.

13. The coated snack food prepared by the process of claim 10, wherein the oven is a modular rotary oven.

14. The coated snack food prepared by the process of claim 10, wherein the tacking solution comprises 44 wt % sugar, 44 wt % water, and about 11 wt % modified potato starch.

15. The coated snack food prepared by the process of claim 14, wherein tacking solution is added in unequal increments.

16. The coated snack food prepared by the process of claim 10 wherein the coated seeds are spun in the rounding drum from about 8 minutes to about 10 minutes.

17. The coated snack food prepared by the process of claim 10, wherein the density of the wet coated seeds is between about 0.67 g/mL and about 0.70 g/mL.

18. The coated snack food prepared by the process of claim 10, wherein the density of the cooked, coated seeds is between about 0.35 g/mL and about 0.43 g/mL.
